(19) United States
(12) Patent Application Publication
(10) Pub. No.: US 2010/0007484 A1
(43) Pub. Date: Jan. 14, 2010

(54) VOICE ALARM AND A CONTROL APPARATUS FOR CONSTRUCTION SITE

(76) Inventor: Moon Seok Song, Seoul (KR)

Correspondence Address: JORDAN AND HAMBURG LLP, 122 EAST 42ND STREET, SUITE 4000, NEW YORK, NY, 10168, US

(21) Appl. No.: 12/448,702

(22) PCT Filed: Feb. 23, 2007
(86) PCT No.: PCT/KR2007/000948

§ 371 Date: Jul. 23, 2009

(30) Foreign Application Priority Data
Jan. 8, 2007 (KR) 10-2007-0001937

(51) Int. Cl. G08B 1/08

(52) U.S. Cl. 340/533; 340/539.1

(57) ABSTRACT

The present invention relates to a voice alarm and a control apparatus for construction site. A voice alarm apparatus in accordance with one aspect of the present invention comprises a sensing unit for generating and transmitting a sensing signal to a processing unit upon detecting the presence of a man in a predetermined area; a wireless communication unit for receiving sound data or user's voice from the outside; a storing unit for storing the sound data or the user's voice from the wireless communication unit; a processing unit for transmitting the sound data or the user's voice stored in the storing unit to an output unit in case of receiving the sensing signal from the sensing unit; and an output unit for outputting the sound by transforming the sound data.

### TECHNICAL FIELD

The present invention relates to a voice alarm and a control apparatus for construction site, and more particularly, to an apparatus capable of preventing safety accident at construction site in advance by notifying workers necessary safety warning.

### BACKGROUND ART

At construction site, there are a variety of work simultaneously, and considerable safety accident occurs to workers due to environment peripheral to the construction site or carelessness of the worker, which causes workers to perform repetitive working process.

For example, at slav construction site, it is essential to form the opening in order to connect or form different structure in the slav between layers, thereby the opening is exposed to safety accident for a long time till curing.

In order to prevent such an accident, although various safeguards are installed around the construction site to provide workers with safety, it has problems that workers tend to be absent-minded because those safeguard are merely visual.

Moreover, at concrete construction site, it should be protected from a physical impact till its curing. However, it is not that easy to identify curing with the naked eye, thereby causing workers pass without attention.

In order to solve such a problem, it is disclosed to install the warning tape for blocking along the periphery of the concrete construction site. However, the warning tape have a weak durability.

### DISCLOSURE OF INVENTION

### Technical Problem

Accordingly, the present invention has been made to solve the above-mentioned problems occurring in the prior art, and an object of the present invention is to provide an apparatus capable of preventing safety accident at construction site in advance by notifying workers necessary safety warning.

### Technical Solution

In order to achieve the above mentioned objects, a voice alarm apparatus in accordance with one aspect of the present invention comprises a sensing unit for generating and transmitting a sensing signal to a processing unit upon detecting the presence of a man in a predetermined area; a wireless communication unit for receiving sound data or user's voice from the outside; a storing unit for storing the sound data or the user's voice from the wireless communication unit; a processing unit for transmitting the sound data or the user's voice stored in the storing unit to an output unit in case of receiving the sensing signal from the sensing unit; and an output unit for outputting the sound by transforming the sound data.

In the above aspect of the present invention, in order to strengthen security, the voice alarm apparatus is characterized in comprising the storing unit further stores an identifier for performing specific identification for the apparatus and the wireless communication unit receives the sound data or the user's voice corresponding to the specific identification information selectively.

In the above aspect of the present invention, the wireless communication unit of the voice alarm apparatus might be performed under wireless LAN protocol or Bluetooth protocol.

In order to achieve the above mentioned objects, a voice control apparatus in accordance with another aspect of the present invention comprises a cable or wireless communication unit for receiving or transmitting sound data from the outside corresponding to an identifier and the specific identification information for a voice alarm apparatus; an input unit for performing input of user's command or voice; a storing unit for storing the sound data from the communication unit corresponding to the identifier and the specific identification information for the voice alarm apparatus, or the user's voice inputted into the input unit; a display unit for displaying the functional state of the apparatus visually; and a processing unit for controlling storage of the sound data or the voice from the communication unit or the input unit respectively in the storing unit, transmission of the sound data or the voice stored in the storing unit via the communication unit to the external voice alarm apparatus for construction site having corresponding identifier according to the user's input, and display of the functional state of the apparatus.

In the above aspect of the present invention, the voice control apparatus might comprise the input unit including a controller capable of selecting the identifier for performing identifying by the user.

In the above aspect of the present invention, the wireless communication unit of the voice control apparatus might perform communication under USB communication, wireless LAN protocol or Bluetooth protocol.

### Advantageous Effects

According to the apparatus of the present invention, it is possible to prevent safety accident or damage at construction site in advance by automatically notifying workers necessary safety warning according to each sector.

### BRIEF DESCRIPTION OF THE DRAWINGS

FIG. 1 shows a block diagram of a voice alarm apparatus for construction site in accordance with an embodiment of the present invention;

FIG. 2 shows a block diagram of a voice control apparatus for construction site in accordance with another embodiment of the present invention;

FIG. 3 shows an example in accordance with an embodiment of the present invention.

### BEST MODE FOR CARRYING OUT THE INVENTION

Hereinafter, an embodiment of the present invention will be described with reference to the accompanying drawings.

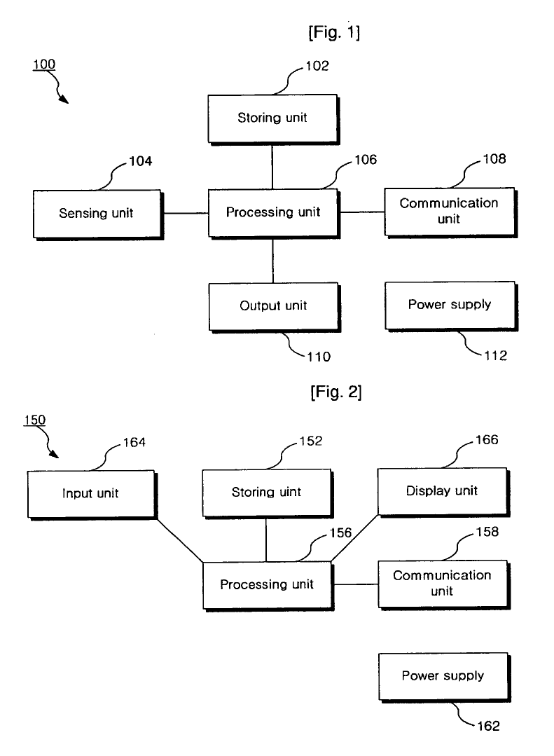

In the following, voice alarm and control apparatus in accordance with embodiments of the present invention will be explained with references to FIGS. 1 and 2.

FIG. 1 shows a block diagram of a voice alarm apparatus for construction site in accordance with an embodiment of the present invention and FIG. 2 shows a block diagram of a voice control apparatus for construction site in accordance with another embodiment of the present invention.

As shown in FIG. 1, the voice alarm apparatus for construction site (hereinafter, simply referred to as alarm apparatus) in accordance with an embodiment of the present invention comprises storing unit 102, sensing unit 104, communication unit 108, output unit 110 and power supply 112 having processing unit 106 as a pivot. Further, to avoid confusion with each element of control apparatus 150 will be mentioned later, each element of alarm apparatus 100 such as processing unit, storing unit, sensing unit, communication unit, output unit and power supply will be named processing unit to the alarm apparatus side, storing unit to the alarm apparatus side, sensing unit to the alarm apparatus side, communication unit to the alarm apparatus side, output unit to the alarm apparatus side and power supply to the alarm apparatus side.

The sensing unit to the alarm apparatus side 104 generates and transmits a sensing signal to a processing unit to the alarm apparatus side 106 upon detecting the presence of a man in a predetermined area.

The communication unit to the alarm apparatus side 108 receives sound data or user's voice from the outside via cable or wireless. It is preferable that the communication unit to the alarm apparatus side 108 performs communication under wireless LAN protocol or Bluetooth protocol. On the other hand, it is also preferable that the communication unit to the alarm apparatus side 108 receives the sound data or user's voice corresponding to the specific identification information selectively, which makes it possible to receive the sound data or user's voice specifically necessary to the alarm apparatus 100 installed in each construction site.

The storing unit to the alarm apparatus side 102 stores the sound data or user's voice received via the communication unit to the alarm apparatus side 108.

The processing unit to the alarm apparatus side 106 transmits the sound data or the user's voice stored in the storing unit to the alarm apparatus side 102 to an output unit to the alarm apparatus side 110 in case of receiving the sensing signal from the sensing unit to the alarm apparatus side 104.

The output unit to the alarm apparatus side 110 outputs the sound by transforming the sound data transmitted from the storing unit to the alarm apparatus side 102 under control of the processing unit to the alarm apparatus side 106. Therefore, the output unit to the alarm apparatus side 110 might be composed of Codec transforming data into sound signal and speaker outputting the sound signal into sound.

The power supply to the alarm apparatus side 112 provides each element of the alarm apparatus 100 with necessary power.

As shown in FIG. 2, the voice control apparatus for construction site (hereinafter, simply referred to as control apparatus) in accordance with another embodiment of the present invention comprises input unit to the control apparatus side 164, storing unit to the control apparatus side 152, display unit to the control apparatus side 166, communication unit to the control apparatus side 158 and power supply unit to the control apparatus side 162 having processing unit to the control apparatus side 162 as a pivot.

The cable or wireless communication unit to the control apparatus side 158 receives or transmits sound data from the outside corresponding to an identifier and the specific identification information for a voice alarm apparatus 100. The communication unit to the control apparatus side 158 performs communication under USB communication for communicating with such as computer, wireless LAN protocol or Bluetooth protocol in here.

The input unit to the control apparatus side 164 performs input of user's command as a sound data or user's voice. Therefore, the input unit to the control apparatus side 164 might include selection apparatus that admits the user to select identifier performing identification and microphone for inputting the sound data or voice.

The storing unit to the control apparatus side 152 stores the sound data from the communication unit to the control apparatus side 158 corresponding to the identifier and the specific identification information for the voice alarm apparatus, or the user's voice inputted into the input unit to the control apparatus side 164.

The display unit to the control apparatus side 166 displays the functional state of the control apparatus 150 visually.

The processing unit to the control apparatus side 156 controls storage of the sound data or the voice from the communication unit to the control apparatus side 158 or the input unit to the control apparatus side 164 respectively in the storing unit to the control apparatus side 152, transmission of the sound data or the voice stored in the storing unit to the control apparatus side 152 via the communication unit to the control apparatus side 158 to the external voice alarm apparatus 100 for construction site having corresponding identifier according to the user's input, and display in the display unit to the control apparatus side 166 of the functional state of the control apparatus 150.

The power supply to the control apparatus side 162 provides each element of the control apparatus 150 with necessary power.

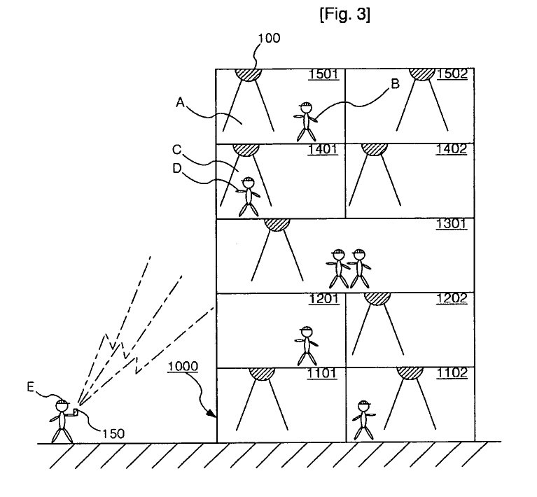

Hereinafter, an example in accordance with an embodiment of the present invention will be described with reference to FIG. 3.

FIG. 3 shows an example in accordance with an embodiment of the present invention.

As shown in FIG. 3, it is assumed that the alarm apparatus 100 having identifier performing identification specific to each room 1101 through 1502 of five-story building are installed. It is assumed that construction supervisor E carries the control apparatus 150 respectively. Further, it is also assumed to be possible that there is wireless communication between the control apparatus 150 and the alarm apparatus 100.

Furthermore, it is assumed that the control apparatus 150 includes power button for selecting supplying power or not, sound recording button for recording, replay button for replaying recorded sound, repetition button for repeating specific portion, stop button for quitting function, elimination button for eliminating recorded sound, hold button for preventing malfunction, volume control button for controlling the volume, transmission button for transmitting the recorded sound to the alarm apparatus, and identification button for selecting the characteristic identification ID of the alarm apparatus. The user can use at least two buttons of the above-mentioned buttons simultaneously as occasion demands in here. For example, the different functions might be accomplished by pushing one of the buttons short not longer that 0.5 second or long not shorter than 1 second.

At a first step, the supervisor E connects the communication unit to the control apparatus side 158 with PC (Personal Computer, not shown), then stores the sound data in the storing unit to the control apparatus side 152. At this time, power starts to be provided with the alarm apparatus 100 upon operating the power button. And then, the functional state of the alarm apparatus 100 is displayed in the display window of the alarm apparatus 100.

At a second step, the supervisor E moves around the building 1000, the construction site, carrying the control apparatus 150.

At a third step, the supervisor E selects warning contents necessary to the alarm apparatus 100 according to characteristic identification ID in the input unit to the control apparatus side 164, and then transmits it to the alarm apparatus 100 via the communication unit to the control apparatus side 158 by means of such as Bluetooth protocol. The supervisor E might listen to the warning contents in advance by using the replay button of the control apparatus 150 in here. Further, he or she might transmit the warning contents to the characteristic alarm apparatus 100 using identification button. Unless there is necessary warning contents in the storing unit to the alarm apparatus side 152, the supervisor E might record appropriate warning contents via microphone belonging to the input unit 164 of his or her free will. In other words, the record function might be performed by using the record button of the alarm apparatus 100.

Accordingly, for example, warning against electric shock and off-limits area might be transmitted to RM# 1501 and RM# 1401 respectively.

At a fourth step, the alarm apparatus 100 monitors or detects the presence of the workers B, D in the predetermined area A, C of the sensing unit to the alarm apparatus side 104.

At a fifth step, similar to RM# 1401, in case of sensing the presence of worker D in the predetermined area C, the output unit to the alarm apparatus side 110 warns worker not to touch the inside wall until the wall is completed.

That is, according to the apparatus of the present invention, it is possible to prevent safety accident or damage at construction site in advance by automatically notifying workers a variety of necessary safety warning according to each sector via audible voice.

### INDUSTRIAL APPLICABILITY

A preferred embodiment of the present invention has been described with reference to the accompanying drawings. However, it is intended that the present invention not be limited to the particular embodiment and those skilled in the art will appreciate that various modifications, additions and substitutions are possible, without departing from the scope and spirit of the invention.

1. A voice alarm apparatus for construction site comprising:
a sensing unit for generating and transmitting a sensing signal to a processing unit upon detecting the presence of a man in a predetermined area;
a wireless communication unit for receiving sound data or user's voice from the outside;
a storing unit for storing the sound data or the user's voice from the wireless communication unit;
a processing unit for transmitting the sound data or the user's voice stored in the storing unit to an output unit in case of receiving the sensing signal from the sensing unit; and
an output unit for outputting the sound by transforming the sound data transmitted from the storing unit under control of the processing unit.

2. The voice alarm apparatus of claim 1, wherein the storing unit further stores an identifier for performing specific identification for the apparatus and the wireless communication unit receives the sound data or the user's voice corresponding to the specific identification information selectively.

3. The voice alarm apparatus of claim 1, wherein the wireless communication unit performs communication under wireless LAN protocol or Bluetooth protocol.

4. A voice control apparatus for construction site comprising:
a cable or wireless communication unit for receiving or transmitting sound data from the outside corresponding to an identifier and the specific identification information for a voice alarm apparatus;
an input unit for performing input of user's command or voice;
a storing unit for storing the sound data from the communication unit corresponding to the identifier and the specific identification information for the voice alarm apparatus, or the user's voice inputted into the input unit;
a display unit for displaying the functional state of the apparatus visually; and
a processing unit for controlling storage of the sound data or the voice from the communication unit or the input unit respectively in the storing unit,
transmission of the sound data or the voice stored in the storing unit via the communication unit to the external voice alarm apparatus for construction site having corresponding identifier according to the user's input, and display of the functional state of the apparatus.

5. The voice control apparatus of claim 4, wherein the input unit includes a controller capable of selecting the identifier for performing identifying by the user.

6. The voice control apparatus of claim 4, wherein the wireless communication unit performs communication under USB communication, wireless LAN protocol or Bluetooth protocol.
